(19) United States
(12) Patent Application Publication
(10) Pub. No.: US 2024/0331400 A1
(43) Pub. Date: Oct. 3, 2024

(54) THRESHOLD-VALUE SETTING DEVICE AND THRESHOLD-VALUE SETTING METHOD

(71) Applicant: Panasonic Automotive Systems Co., Ltd., Kanagawa (JP)

(72) Inventors: Ryo ITO, Osaka (JP); Jun IMAMURA, Osaka (JP); Takayuki SUZUKI, Kanagawa (JP); Tatsuki HOTANI, Kanagawa (JP); Akitoshi YAMASHITA, Hyogo (JP)

(73) Assignee: Panasonic Automotive Systems Co., Ltd., Kanagawa (JP)

(21) Appl. No.: 18/615,788

(22) Filed: Mar. 25, 2024

(30) Foreign Application Priority Data
Mar. 29, 2023 (JP) 2023-053990

(51) Int. Cl. G06V 20/58; B60R 1/26; H04N 23/63

(52) U.S. Cl. CPC G06V 20/58; B60R 1/26; H04N 23/634

(57) ABSTRACT

A threshold-value setting device sets a threshold value corresponding to a predetermined distance in order to give a user a warning about a warning object approaching within a distance less than the predetermined distance, and includes a threshold-value processor and an image processor. The threshold-value processor acquires a vertical position in a camera image obtained by image capturing of surroundings of the vehicle with the camera, i.e., a designated position in accordance with a user's operation and generates an icon having a size appropriate to the designated position and having a shape imitating the shape of the warning object. The image processor superimposes the icon on the designated position in the camera image and displays the icon-superimposed camera image on a display. The threshold-value processor sets the designated position as the threshold value in accordance with a determination operation performed by the user based on the displayed icon.

### CROSS REFERENCE TO RELATED APPLICATION

The present application is based on and claims priority of Japanese Patent Application No. 2023-053990 filed on Mar. 29, 2023.

### FIELD

The present disclosure relates to a device or the like for setting a threshold value corresponding to a predetermined distance from a vehicle in order to give a user a warning that a warning object is approaching within a distance less than the predetermined distance from the vehicle.

### BACKGROUND

A warning system has conventionally been proposed in which a warning is given to a user when a rear vehicle running behind a user's vehicle is approaching within a distance less than a predetermined distance from the user's vehicle. Such a warning system includes a camera and an electronic mirror used as a rear-view mirror or a driving mirror. The electronic mirror displays an image obtained by image capturing with the camera. The image shows objects such as a rear vehicle. The user of the vehicle is able to set a threshold value corresponding to the aforementioned predetermined distance by designating a vertical position in the image seen in the electronic mirror. That is, a warning is issued if the rear vehicle is shown below the position designated by the user in the image seen in the electronic mirror. Thus, the designated position is treated as the threshold value.

In the conventional warning system, a horizontal line is shown in the image seen in the electronic mirror in order to accept designation of the position in the image. The user moves the horizontal line in the vertical direction so as to set a desired position on the horizontal line as the threshold value. That is, the warning system includes a threshold-value setting device for setting the threshold value.

Patent Literature (PTL) 1 discloses a supervised-area setting device provided in a supervisory camera. The supervised-area setting device sets, as a supervised area, an area to be supervised in an image captured by the supervisory camera. Specifically, the supervised-area setting device detects three markers provided in a horizontal plane that is to be supervised in real space through image processing, and sets a supervised area by using a straight line connecting the three markers.

The conventional threshold-value setting device sets the threshold value for warning by using the horizontal line as in the case of the supervised-area setting device described above in PTL 1 that sets the supervised area by using the straight line.

### CITATION LIST

### Patent Literature

PTL 1: Japanese Patent No. 4140159

### SUMMARY

However, the conventional threshold-value setting device can be improved upon.

In view of this, the present disclosure provides a threshold-value setting device or the like that can be further improved upon.

A threshold-value setting device according to one aspect of the present disclosure is a threshold-value setting device for setting a threshold value that corresponds to a predetermined distance from a vehicle in order to give a user a warning about a warning object approaching within a distance less than the predetermined distance. The threshold-value setting device includes a threshold-value processor and an image processor. The threshold-value processor acquires a designated position in accordance with an operation by a user, the designated position being a vertical position in a camera image obtained by image capturing of surroundings of the vehicle with a camera provided to the vehicle, and generates an icon having a size appropriate to the designated position and a shape imitating a shape of the warning object. The image processor superimposes the icon generated, on the designated position in the camera image and displays, on a display, the camera image on which the icon has been superimposed as an icon-superimposed image. The threshold-value processor sets the designated position as the threshold value in accordance with a determination operation performed by the user based on the icon-superimposed image displayed.

It is to be noted that such a generic or specific aspect of the present disclosure may be embodied as a system, a method, an integrated circuit, a computer program, or a computer-readable recording medium such as a CD-ROM, or may be embodied as any combination of a system, a method, an integrated circuit, a computer program, and a recording medium. The recording medium may be a non-transitory recording medium.

The threshold-value setting device according to the present disclosure can be further improved upon.

Further advantages and effects of one aspect of the present disclosure become apparent from the specification and the drawings. These advantages and/or effects are provided by configurations to be described in some embodiments and in the specification and drawings, but not necessarily all of the configurations are required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing one example of a cabin in which a warning system according to Embodiment 1 is installed.

FIG. 2 is a block diagram showing a configuration of the warning system according to Embodiment 1.

FIG. 3 is a diagram showing one example of an icon-superimposed image according to Embodiment 1.

FIG. 4 is a flowchart showing one example of a processing operation of a threshold-value setting device according to Embodiment 1.

FIG. 5 is a block diagram showing a configuration of a warning system according to Embodiment 2.

FIG. 6 is a diagram for describing second threshold-value setting processing using a line-superimposed image according to Embodiment 2.

FIG. 7 is a flowchart showing one example of a processing operation of a threshold-value setting device according to Embodiment 2.

FIG. 8 is a flowchart showing one detailed example of the second threshold-value setting processing according to Embodiment 2.

FIG. 9 is a block diagram showing a configuration of a warning system according to Embodiment 3.

FIG. 10 is a diagram for describing second threshold-value setting processing using frames according to Embodiment 3.

FIG. 11 is a flowchart showing one detailed example of the second threshold-value setting processing according to Embodiment 3.

FIG. 12 is a block diagram showing a configuration of a warning system according to Embodiment 4.

FIG. 13 is a diagram for describing second threshold-value setting processing using a recorded image according to Embodiment 4.

FIG. 14A is a flowchart showing one example of a processing operation of a recorder according to Embodiment 4.

FIG. 14B is a flowchart showing one detailed example of second threshold-value setting processing according to Embodiment 4.

FIG. 15 is a block diagram showing a configuration of a warning system according to Embodiment 5.

FIG. 16A is a diagram showing one example of an image displayed in second threshold-value setting processing according to Embodiment 5.

FIG. 16B is a diagram showing one example of another image displayed in the second threshold-value setting processing according to Embodiment 5.

FIG. 17A is a flowchart showing one detailed example of the second threshold-value setting processing according to Embodiment 5.

FIG. 17B is a flowchart showing another detailed example of the second threshold-value setting processing according to Embodiment 5.

### DESCRIPTION OF EMBODIMENTS

The aforementioned conventional threshold-value setting device has difficulty in showing how far the position of the horizontal line is away from the vehicle in real space. That is, it is difficult to know the relationship between the position of the horizontal line and the distance between the vehicle and the warning object in real space. In the case where the image shows neither marks nor indication that allows the user to grasp size or distance in real space, the user has to drive the vehicle so as to capture an image of a mark or indication with the camera in order to grasp the aforementioned relationship. At this time, the user also needs to be aware of rear vehicles running on the road. Thus, setting the threshold value may involve danger. As a result, an issue arises in that the user has difficulty in setting an appropriate threshold value. Besides, grasping the aforementioned relationship becomes more difficult if the user has just purchased the warning system or a vehicle equipped with the warning system. In this case, there is a high possibility that the user cannot set an appropriate threshold value.

In view of this, a threshold-value setting device according to a first aspect of the present disclosure is a threshold-value setting device for setting a threshold value that corresponds to a predetermined distance from a vehicle in order to give a user a warning about a warning object approaching within a distance less than the predetermined distance. The threshold-value setting device includes a threshold-value processor and an image processor. The threshold-value processor acquires a designated position in accordance with an operation by a user, the designated position being a vertical position in a camera image obtained by image capturing of surroundings of the vehicle with a camera provided to the vehicle, and generates an icon having a size appropriate to the designated position and a shape imitating a shape of the warning object. The image processor superimposes the icon generated, on the designated position in the camera image and displays, on a display, the camera image on which the icon has been superimposed as an icon-superimposed image. The threshold-value processor sets the designated position as the threshold value in accordance with a determination operation performed by the user based on the icon-superimposed image displayed.

In this way, when the user operates the designated position, the icon having a size appropriate to the designated position and having a shape imitating the shape of the warning object is superimposed and displayed on the designated position in the camera image. The warning object may, for example, be a rear vehicle running behind the vehicle. Then, for example, as the designated position is located lower, a larger icon may be displayed on the designated position, and conversely as the designated position is located higher, a smaller icon may be displayed on the designated position. Therefore, the icon shown in the camera image looks like the warning object that is running behind and away from the vehicle by a distance appropriate to the designated position. As a result, taking a look at the icon allows the user to easily grasp the relationship between the designated position and the distance from the vehicle to the warning object. Then, the user is easily able to set the designated position as the threshold value by performing the determination operation while looking at the icon. Accordingly, it is possible to easily set an appropriate threshold value for warning.

The threshold-value setting device according to a second aspect dependent on the first aspect may further include an object detector that detects another vehicle running in a vicinity of the vehicle through image recognition processing performed on the camera image. When no vehicles are detected, the image processor and the threshold-value processor may perform first threshold-value setting processing in which the threshold value is set by displaying the icon-superimposed image, and when the other vehicle is detected, the image processor and the threshold-value processor may perform second threshold-value setting processing in which the threshold value is set without displaying the icon-superimposed image.

For example, in the case where the camera image shows a rear vehicle running behind the vehicle as the other vehicle and when the icon is superimposed on and displayed in the camera image, the icon may possibly be superimposed on the image of the other vehicle. Thus, the user may face the difficulty of recognizing the icon and may be unable to easily set the threshold value. According to the second aspect, on the other hand, in the case where the camera image shows the other vehicle, the other vehicle is detected and the threshold value is set without display of the icon-superimposed image, i.e., without superimposition and display of the icon in the camera image. That is, the second threshold-value setting processing is performed. In the case where the camera image does not show any other vehicle, the first threshold-value setting processing is performed in which the aforementioned icon is superimposed on and displayed in the camera image. In this way, in the case where there is a possibility that the recognition of the icon may become difficult, the threshold value is set without display of the icon. This lessens troublesome operations for setting the threshold value.

In the threshold-value setting device according to a third aspect dependent on the second aspect, in the second threshold-value setting processing, the image processor may superimpose, on the camera image, a horizontal line passing through the designated position in the camera image and display, on the display, the camera image on which the horizontal line has been superimposed as a line-superimposed image, and the threshold-value processor may set the designated position as the threshold value in accordance with a determination operation performed by the user based on the line-superimposed image displayed.

In this way, in the second threshold-value setting processing, the horizontal line is superimposed and displayed on the designated position in the camera image. Thus, even if the horizontal line is superimposed on the image of the other vehicle, it is possible to reduce the possibility that the user may have difficulty in recognizing the horizontal line. Then, the user is easily able to set the designated position as the threshold value by performing the degermation processing while looking at the horizontal line. Accordingly, it is possible to easily set an appropriate threshold value for warning, irrespective of whether the camera shows another vehicle.

In the threshold-value setting device according to a fourth aspect dependent on the second aspect, in the second threshold-value setting processing, the image processor may display the camera image on the display without superimposing any object on the camera image that shows the other vehicle, and the threshold-value processor may set, as the threshold value, a vertical position of the other vehicle shown in a frame selected according to a selection operation by the user from among a plurality of frames included in the camera image that shows the other vehicle. Note that the camera image is a moving image consisting of a plurality of frames.

For example, in the case where another vehicle far apart is going pass the ego-vehicle while the vehicle stops at a road shoulder or is running on a road, the user may perform a frame selection operation while looking at a camera image showing the other vehicle. That is, while looking at the camera image, the user performs the selection operation when a frame showing a situation in which the other vehicle is approaching within a desired distance from the vehicle. According to the fourth aspect, the vertical position of the other vehicle shown in the frame corresponding to the selection operation by the user is set as the threshold value. Thus, the user is easily able to set the threshold value while grasping the relationship between the threshold value and the distance from the vehicle to the warning object (i.e., the other vehicle). Accordingly, it is possible to easily set an appropriate threshold value for warning, irrespective of whether the camera image shows another vehicle.

In the threshold-value setting device according to a fifth aspect dependent on the fourth aspect, when the selection operation is performed by the user, the image processor may superimpose a confirmation icon on a position targeted for superimposition in a base image that does not show the other vehicle and may display, on the display, the base image on which the confirmation icon has been superimposed as a confirmation image, the position targeted for superimposition being a same position as the vertical position of the other vehicle shown in the frame selected according to the selection operation, the confirmation icon having a size appropriate to the position targeted for superimposition and has a shape imitating a shape of the other vehicle, and the threshold-value processor may set the vertical position of the other vehicle as the threshold value in accordance with a determination operation performed by the user based on the confirmation image displayed.

In this way, when the user has performed the section operation, the confirmation image is displayed on the display before the threshold value is set. In this confirmation image, the confirmation icon is superimposed on the base image that does not show any other vehicle. Thus, the user is easily able to recognize the confirmation icon. Moreover, the confirmation icon has a size appropriate to the vertical position of the other vehicle (i.e., the to-be-superimposed position) shown in the frame selected by the selection operation and has a shape imitating the shape of the other vehicle. Moreover, the vertical position of the other vehicle, i.e., the to-be-superimposed position, is assumed as the provisional threshold value. Thus, the user is easily able to grasp the relationship between the provisional threshold value and the distance from the vehicle to the warning object by looking at the confirmation icon. Then, the user is easily able to set the vertical position of the other vehicle as the threshold value by performing the determination operation while looking at the confirmation icon. Accordingly, it is possible to easily set an appropriate threshold value for warning, irrespective of whether the camera image shows another vehicle.

The threshold-value setting device according to a sixth aspect dependent on the second aspect may further include a recorder that records the camera image as a recorded image when the other vehicle is not detected. The icon-superimposed image is an image obtained by superimposing the icon generated on the camera image obtained by current image capturing with the camera. In the second threshold-value setting processing, the image processor may superimpose the icon generated, on the designated position in the recorded image recorded in the past and display, on the display, the recorded image on which the icon has been superimposed as an icon-superimposed recorded image, and the threshold-value processor may set the designated position as the threshold value in accordance with a determination operation performed by the user based on the icon-superimposed recorded image displayed.

In this way, in the second threshold-value setting processing, the icon is superimposed on and displayed in the recorded image, which is the camera image that is recorded in the past and does not show the other vehicle. Thus, the user is easily able to recognize the icon. Then, the user is easily able to set the designated position as the threshold value by performing the determination operation while looking at the icon. Accordingly, it is possible to easily set an appropriate threshold value for warning, irrespective of whether the camera image shows another vehicle.

The threshold-value setting device according to a seventh aspect dependent on the second aspect may further include a distance converter that performs distance conversion processing for converting a vertical position of the other vehicle shown in the camera image into a vehicle-to-vehicle distance from the vehicle to the other vehicle, and a recorder that records a plurality of frames included in the camera image. When recording the plurality of frames, the recorder may record, for each of a plurality of set distances defined in advance, a frame that corresponds to the vehicle-to-vehicle distance equal to the set distance. In the second threshold-value setting processing, the image processor may display the plurality of frames recorded on the display in association with the plurality of set distances, respectively, and the threshold-value processor may set, as the threshold value, the vertical position of the other vehicle shown in a frame selected by a selection operation by a user from among the plurality of frames displayed. Note that the camera image is a moving image consisting of a plurality of frames.

For example, a case is assumed in which another vehicle far apart is going pass the ego-vehicle while the vehicle stops at a road shoulder or is running on a road. If the vehicle-to-vehicle distance between the vehicle and the other vehicle matches one of the plurality of set distances, a frame showing the other vehicle that is located away from the vehicle by the vehicle-to-vehicle distance is recorded. In a specific example, a frame corresponding to a vehicle-to-vehicle distance of 10 m, a frame corresponding to a vehicle-to-vehicle distance of 20 m, and a frame corresponding to a vehicle-to-vehicle distance of 30 m are recorded. Note that each of these vehicle-to-vehicle distances matches one of the plurality of set distances. Each of the plurality of set distances corresponds to a vertical position in the frame, i.e., a candidate for the threshold value. Thereafter, if the vehicle is running, after the user checks safety by, for example, stopping the vehicle at a road shoulder, these frames are displayed in association respectively with the plurality of set distances, and the vertical position of the other vehicle shown in the frame selected from among these frames in accordance with the selection operation by the user is set as the threshold value. Thus, the user is easily able to set a desired threshold value by selecting a frame while grasping, for each of the plurality of frames, the relationship between the candidate for the threshold value corresponding to the frame and the vehicle-to-vehicle distance corresponding to the frame with ease and without haste. Accordingly, it is possible to easily set an appropriate threshold value for warning, irrespective of whether the camera image shows another vehicle.

Hereinafter, embodiments will be described in detail with reference to the drawings.

Each embodiment described below illustrates one generic or specific example of the present disclosure. Thus, numerical values, shapes, materials, constituent elements, arrangement positions and forms of connection of the constituent elements, steps, sequence of steps, and so on in the following embodiments are mere examples and do not intend to limit the scope of the present disclosure. Among the constituent elements described in the following embodiments, those that are not recited in any independent claim, which represents the broadest concept, are described as optional constituent elements. Note that each drawing is a schematic diagram and does not necessarily provide precise depiction. Substantially the same structural elements are given the same reference signs throughout the drawings.

### Embodiment 1

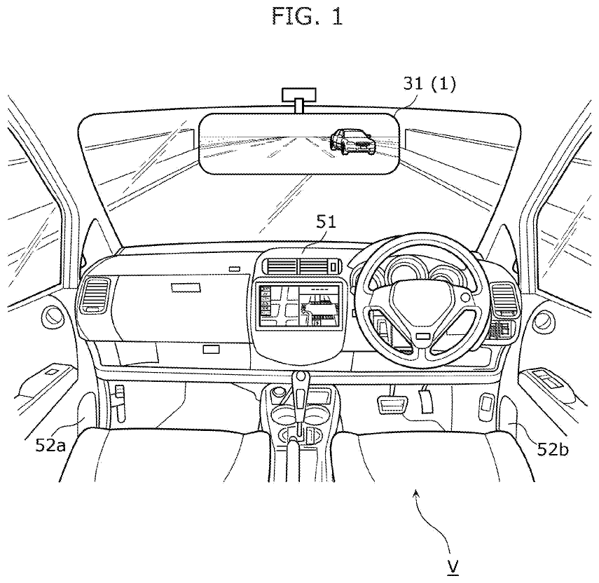

FIG. 1 is a diagram showing one example of a cabin in which a warning system according to the present embodiment is installed.

Warning system 1 according to the present embodiment is mounted on vehicle V. Warning system 1 includes electronic mirror 31 used as a rear-view mirror or a driving mirror. Electronic mirror 31 includes a liquid crystal display or an organic electro-luminescence (EL) display and displays an image obtained by image capturing with a camera provided in the rear part of vehicle V. This image is hereinafter also referred to as a camera image. Warning system 1 gives a warning to a user of vehicle V when a rear vehicle shown in the camera image is approaching within a distance less than a predetermined distance from vehicle V. The user may be a driver of vehicle V, or may be a passenger of vehicle V. For example, the predetermined distance may be adjusted by a component such as a slider bar or a switch provided to instrumental panel 51 or electronic mirror 31 of vehicle V. The warning may be given by, for example, sound output from left speaker 52a and right speaker 52b of vehicle Va or from a speaker provided in electronic mirror 31. Alternatively, the warning may be given by, for example, display of a warning mark or the like on electronic mirror 31 or a display of instrumental panel 51.

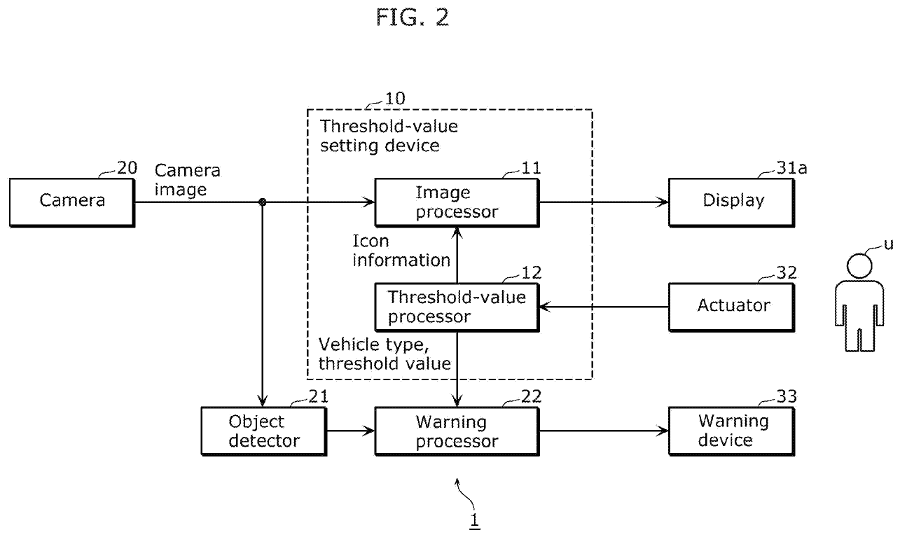

FIG. 2 is a block diagram showing a configuration of warning system 1.

Warning system 1 includes threshold-value setting device 10, camera 20, object detector 21, warning processor 22, display 31a, actuator 32, and warning device 33.

Display 31a may, for example, be a liquid crystal display or an organic EL display and is provided in electronic mirror 31.

Actuator 32 may, for example, be a slider bar or a switch and is configured to accept operation from user u of vehicle V and output an actuating signal responsive to the operation. Actuator 32 may be provided to electronic mirror 31, or may be provided to instrumental panel 51. Actuator 32 may also be configured integrally with display 31a of electronic mirror 31. In this case, actuator 32 and display 31a are integrally configured as a touch panel.

Camera 20 is provided in the rear part of vehicle V and configured to capture an image of the rear of vehicle V and output a camera image that is an image obtained by the image capturing. The camera image according to the present disclosure is basically a moving image obtained with the timing of image capturing, but is not limited thereto and may be a still image.

Object detector 21 acquires a camera image from camera 20 and performs image recognition processing on the camera image so as to detect other vehicles running in the vicinity of vehicle V, which are objects shown in the camera image. For example, object detector 21 may detect a rear vehicle running behind vehicle V as an object and output detection information indicating the result of the detection. The detection information may indicate, for example, the position of the rear vehicle detected in the camera image and the type of the object (e.g., vehicle type).

Warning processor 22 acquires the detection information from object detector 21 and determines whether the position of the rear vehicle in the camera image indicated by the detection information is at a lower vertical position than a threshold value. When a determination is made that the position of the rear vehicle is below the threshold value, warning processor 22 outputs a warning signal.

Warning device 33 may include, for example, at least either a display or a speaker and, when having acquired the warning signal from warning processor 22, issue a warning about approach of the rear vehicle by displaying an image or outputting sound. Warning device 33 may be configured by left speaker 52a and right speaker 52b, or may be configured as the speaker provided to electronic mirror 31. Warning device 33 may also be configured as display 31a of electronic mirror 31.

Threshold-value setting device 10 sets the aforementioned threshold value used by warning processor 22 in accordance with the actuating signal output from actuator 32. That is, threshold-value setting device 10 is a device for setting a threshold value corresponding to a predetermined distance from vehicle V in order to give vehicle V a warning about a warning object approaching within a distance less than the predetermined distance. The warning object may, for example, be a rear vehicle. Threshold-value setting device 10 includes image processor 11 and threshold-value processor 12.

Threshold-value processor 12 acquires an actuating signal from actuator 32. In the case where the actuating signal is a threshold-value actuating signal, threshold-value processor 12 generates icon information in accordance with the threshold-value actuating signal and outputs the generated icon information to image processor 11. The threshold-value actuating signal indicates the designated position, which is the vertical position in the camera image, and the type of the warning object (specifically, vehicle type). The icon information is information indicating the icon and the designated position. The icon has a size appropriate to the designated position and has a shape imitating the shape of the vehicle of the type indicated by the threshold-value actuating signal. Threshold-value processor 12 generates and outputs the icon information corresponding to the threshold-value actuating signal even time the threshold-value actuating signal is acquired or every time the threshold-value actuating signal is changed. That is, threshold-value processor 12 according to the present embodiment acquires the designated position, which is the vertical position in the camera image obtained by image capturing of surroundings of vehicle V with camera 20 provided to vehicle V, in accordance with operation by user u and generates an icon that has a size appropriate to the designated position and has a shape imitating the shape of the warning object.

In the case where the actuating signal is a determination actuating signal, threshold-value processor 12 sets the designated position indicated by the last acquired threshold-value actuating signal as the threshold value for the vehicle type indicated by the threshold-value actuating signal and outputs the vehicle type and the threshold value to warning processor 22. That is, the vehicle type of the warning object and the threshold value corresponding to the vehicle type are output to warning processor 22. At this time, user u operates actuator 32 such that the determination actuating signal is output, while looking at an icon-superimposed image displayed on display 31a by image processor 11, which will be described later. This operation of actuator 32 is referred to as a determination operation. Accordingly, threshold-value processor 12 according to the present embodiment sets the designated position as the threshold value in accordance with the determination operation performed by user u based on the displayed icon-superimposed image.

Upon acquiring the vehicle type of the warning object and the threshold value corresponding to the vehicle type from threshold-value processor 12, warning processor 22 determines whether the vehicle type indicated by the detection information corresponds to the vehicle type of the warning object. Then, when a determination is made that the vehicle type indicated by the detection information corresponds to the vehicle type of the warning object, warning processor 22 further determines whether the position of the rear vehicle indicated by the detection information is below the threshold value corresponding to the vehicle type of the warning object in the vertical direction. When a determination is made that the position of the rear vehicle is below the threshold value, warning processor 22 outputs the aforementioned warning signal. In this way, in the present embodiment, the threshold value is set for each vehicle type, and when the position of a warning object corresponding to the vehicle type is below the threshold value corresponding to the vehicle type, a warning about the warning object is issued.

Image processor 11 acquires a camera image from camera 20 and displays the camera image on display 31a. Upon acquiring the icon information from threshold-value processor 12, image processor 11 further superimposes an icon indicated by the icon information on the designated position indicated by the icon information in the camera image. Then, image processor 11 displays, on display 31a, the camera image on which the icon has been superimposed, i.e., an icon-superimposed image. That is, image processor 11 according to the present embodiment superimposes the generated icon on the designated position in the camera image and displays, on display 31a, the camera image on which the icon has been superimposed as the icon-superimposed image.

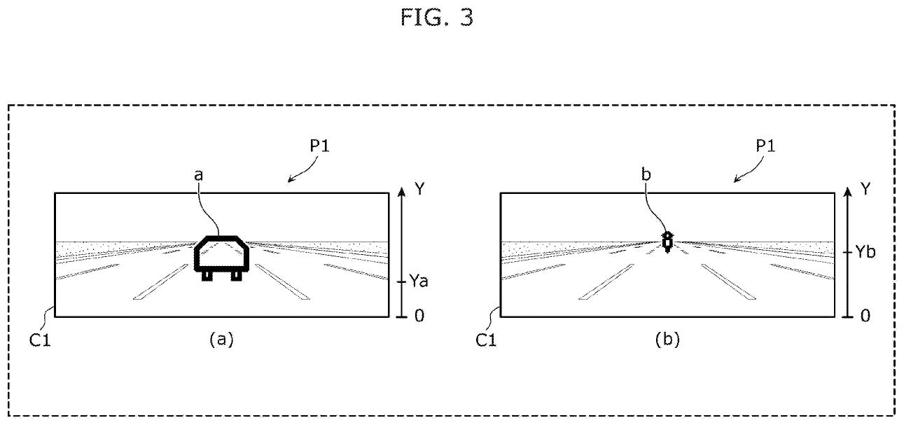

FIG. 3 is a diagram showing one example of the icon-superimposed image.

For example, threshold-value processor 12 generates icon information indicating icon a as shown in (a) in FIG. 3. Specifically, threshold-value processor 12 acquires a threshold-value actuating signal that indicates the vehicle type of “passenger car for private use” and designated position “Ya” from actuator 32. Then, threshold-value processor 12 outputs, to image processor 11, icon information that indicates icon a and designated position “Ya” of the icon, the icon having a size appropriate to designated position “Ya” and a shape imitating the shape of the passenger car for private use. Image processor 11 generates icon-superimposed image P1 by superimposing icon a on designated position “Ya” in camera image C1 and displays the icon-superimposed image on display 31a.

Here, user u changes designated position Ya in the vertical direction (i.e., direction Y) in camera image C1 by operating actuator 32. That is, the threshold-value actuating signal is changed. As a result, threshold-value processor 12 changes the size of icon a in accordance with designated position Ya after the change. For example, threshold-value processor 12 increases the size of icon a as designated position Ya is lower (i.e., closer to 0) and reduces the size of icon a as designated position Ya is higher (i.e., farther from zero). Image processor 11 also moves icon a to designated position Ya after the change. That is, when the passenger car for private use runs at the position corresponding to designated position Ya in real space, icon a superimposed on designated position Ya is displayed in the same size as the size in which the passenger car for private use is shown in camera image C1. Thus, taking a look at icon a in icon-superimposed image P1 allows user u to easily grasp the relationship between the threshold value and the position corresponding to the threshold value in real space or the relationship between the threshold value and the vehicle-to-vehicle distance corresponding to the threshold value in real space. Note that the vehicle-to-vehicle distance is the distance between vehicle V and the passenger car for private use serving as the warning object.

As another example, threshold-value processor 12 may generate icon information that indicates icon b as shown in (b) in FIG. 3. Specifically, threshold-value processor 12 acquires a threshold-value actuating signal that indicates the vehicle type of “motorcycle for private use” and designated position “Yb” from actuator 32. Then, threshold-value processor 12 outputs, to image processor 11, icon information that indicates icon b and designated position “Yb” of this icon, the icon having a size appropriate to designated position “Yb” and a shape imitating the shape of the motorcycle for private use. Image processor 11 generates icon-superimposed image P1 by superimposing icon b on designated position “Yb” in camera image C1 and displays the icon-superimposed image on display 31a.

Here, user u changes designated position Yb in the vertical direction (i.e., direction Y) in camera image C1 by operating actuator 32 in the same manner as described above. That is, the threshold-value actuating signal is changed. As a result, threshold-value processor 12 changes the size of icon b in accordance with designated position Yb after the change. For example, threshold-value processor 12 increases the size of icon b as designated position Yb is lower (i.e., closer to 0) and conversely reduces the size of icon b as designated position Yb is higher (i.e., farther from 0). Image processor 11 also moves icon b to designated position Yb after the change. That is, when the motorcycle for private use runs at the position corresponding to designated position Yb in real space, icon b superimposed on designated position Yb is displayed in the same size as the size in which the motorcycle for private use is shown in camera image C1. Thus, taking a look at icon b in icon-superimposed image P1 allows user u to easily grasp the relationship between the threshold value and the position corresponding to the threshold value in real space or the relationship between the threshold value and the vehicle-to-vehicle distance corresponding to the threshold value in real space. Note that the vehicle-to-vehicle distance is the distance between vehicle V and the motorcycle for private use serving as the warning object.

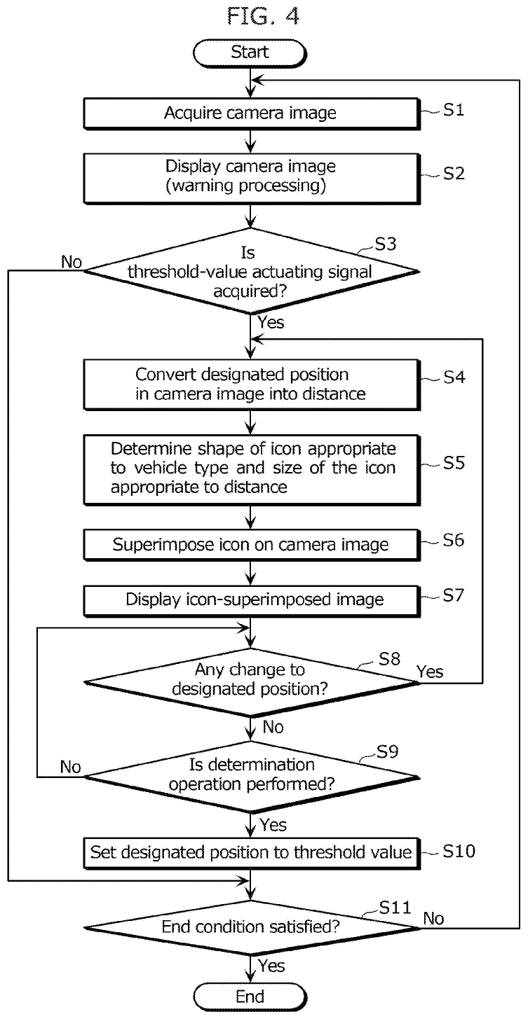

FIG. 4 is a flowchart showing one example of a processing operation of threshold-value setting device 10.

Image processor 11 of threshold-value setting device 10 acquires camera image C1 (step S1) and displays camera image C1 on display 31a (step S2). At this time, when object detector 21 of warning system 1 detects a rear vehicle in camera image C1 and warning processor 22 determines that the rear vehicle is at a position below the threshold value in camera image C1, warning device 33 issues a warning about the approach of the rear vehicle.

Here, threshold-value processor 12 determines whether a threshold-value actuating signal is acquired from actuator 32 (step S3). When threshold-value processor 12 has determined that the threshold-value actuating signal is not acquired (No in step S3), threshold-value setting device 10 performs processing in step S11 described later. On the other hand, when a determination is made that the threshold-value actuating signal is acquired (Yes in step S3), threshold-value processor 12 converts the designated position indicated by the threshold-value actuating signal into distance (step S4). The designated position refers to a vertical position in camera image C1, and the distance refers to a distance from vehicle V to the position corresponding to the designated position in real space. Note that parameters of camera 20 are used in this conversion a 20. Threshold-value processor 12 further determines the shape of an icon that imitates the vehicle type indicated by the threshold-value actuating signal and the size of the icon appropriate to the distance (step S5). In this way, the icon is generated.

For example, for each vehicle type, a correspondence between the distance and the size of the icon for the vehicle type is defined in advance as an mathematical expression or in a table. Threshold-value processor 12 may use this correspondence to determine the size of the icon. Although in steps S4 and S5, the designated position is converted into distance and the size of the icon appropriate to the distance is determined, the size of the icon may be determined directly from the designated position without conversion of the designated position into distance. In this case, for example, for each vehicle type, a correspondence between the designated position and the size of the icon for the vehicle type is defined in advance as a mathematical expression or in a table. Threshold-value processor 12 may use this correspondence to determine the size of the icon.

Then, threshold-value processor 12 generates icon information that indicates the designated position and the icon of the determined size and shape and outputs the icon information to image processor 11.

Upon acquiring the icon information from threshold-value processor 12, image processor 11 superimposes the icon indicated by the icon information on the designated position in camera image C1 indicated by the icon information (step S6). Then, image processor 11 displays, on display 31a, camera image C1 on which the icon has been superimposed, i.e., icon-superimposed image P1 (step S7).

Here, threshold-value processor 12 determines whether the threshold-value actuating signal is changed, i.e., whether the designated position indicated by the threshold-value actuating signal is changed (step S8). When a determination is made that the designated position is changed (Yes in step S8), threshold-value processor 12 repeats execution of the processing from step S4. On the other hand, when a determination is made that the designated position is not changed (No in step S8), threshold-value processor 12 further determines whether a determination actuating signal is acquired from actuator 32 (step S9). When a determination is made that the determination actuating signal is not acquired (No in step S9), threshold-value processor 12 repeats execution of the processing from step S8. On the other hand, when a determination is made that the determination actuating signal is acquired (Yes in step S9), threshold-value processor 12 sets the designated position indicated by the last threshold-value actuating signal as the threshold value (step S10).

Then, threshold-value setting device 10 determines whether end conditions are satisfied (step S11) and repeats execution of the processing from step S1 when a determination is made that the end conditions are not satisfied (No in step S11). On the other hand, when a determination is made that the end conditions are satisfied (Yes in step S11), threshold-value setting device 10 ends all processing. The end conditions may include, for example, power-off of warning system 1 or power-off of the ignition switch of vehicle V, and may be any conditions.

As described thus far, in the present embodiment, when user u operates the designated position, the icon having aa size appropriate to the designated position and a shape imitating the shape of the warning object is superimposed and displayed on the designated position in camera image C1. The warning object may, for example, be a rear vehicle running behind the vehicle. Then, for example, as the designated position is lower, a large icon is displayed on the designated position, and conversely as the designated position is higher, a smaller icon is displayed on the designated position. Therefore, the icon is shown in camera image C1 like the warning object running behind and away from vehicle V by a distance corresponding to the designated position. As a result, taking a look at the icon allows user u to easily grasp the relationship between the designated position and the distance from vehicle V to the warning object. Then, user u is easily able to set the designated position as the threshold value by performing a determination operation while looking at the icon. Accordingly, it is possible to easily set an appropriate threshold value for warning.

### Embodiment 2

A threshold-value setting device according to the present embodiment switches processing for setting a threshold value, depending on whether a camera image shows any other vehicle. Specifically, the processing is switched between first threshold-value setting processing and second threshold-value seating processing, the first threshold-value setting processing being processing for setting the threshold value by superimposing an icon on a camera image as in Embodiment 1, the second threshold-value setting processing being processing for setting a threshold value without superimposing an icon on a camera image. In the second threshold-value setting processing according to the present embodiment, a horizontal line is used instead of an icon.

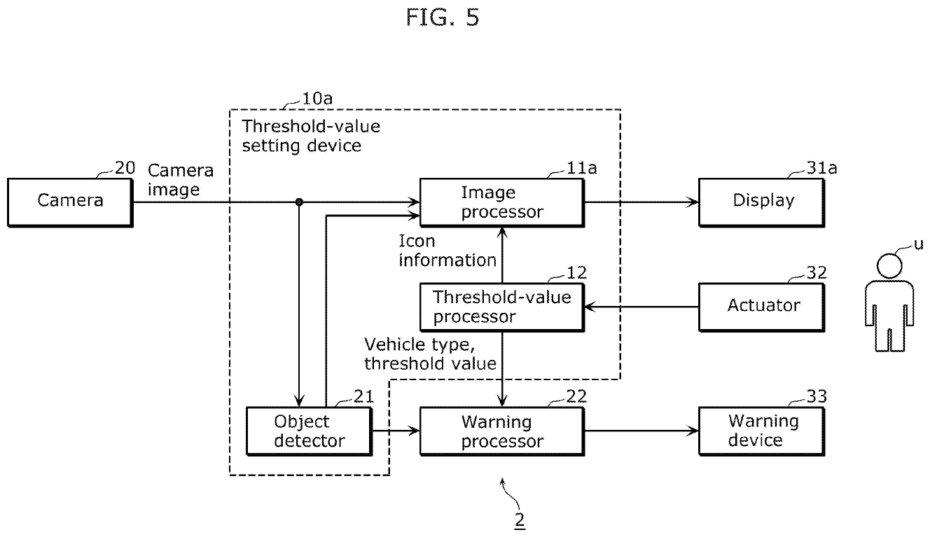

FIG. 5 is a block diagram showing a configuration of a warning system according to the present embodiment.

Warning system 2 according to the present embodiment includes threshold-value setting device 10a, camera 20, warning processor 22, display 31a, actuator 32, and warning device 33. Among constituent elements according to the present embodiment, those that are identical to constituent elements according to Embodiment 1 are given the same reference signs as in Embodiment 1, and detailed description thereof is omitted.

Threshold-value setting device 10a according to the present embodiment includes object detector 21. Threshold-value setting device 10a according to the present embodiment further includes image processor 11a and threshold-value processor 12. Image processor 11a also has the function of image processor 11 according to Embodiment 1. That is, in the case where object detector 21 does not detect any rear vehicle, image processor 11a and threshold-value processor 12 according to the present embodiment display icon-superimposed image P1 on display 31a to set the threshold value as in Embodiment 1. The processing for setting the threshold value as in Embodiment 1 is also referred to as the first threshold-value setting processing. On the other hand, in the case where object detector 21 has detected a rear vehicle, image processor 11a and threshold-value processor 12 according to the present embodiment perform the second threshold-value setting processing for setting the threshold value without displaying icon-superimposed image P1 on display 31a.

Specifically, image processor 11a acquires detection information from object detector 21 and, when the detection information does not indicate any rear vehicle, image processor 11a generates icon-superimposed image P1 as an operation of the first threshold-value setting processing. On the other hand, when the detection information acquired from object detector 21 indicates a rear vehicle, image processor 11a generates line-superimposed image as an operation of the second threshold-value setting processing. That is, in the second threshold-value setting processing, image processor 11a superimposes, on camera image C1, a horizontal line passing through the designated position in camera image C1 and displays, on display 31a, the camera image on which the horizontal line has been superimposed as a line-superimposed image.

In the second threshold-value setting processing, threshold-value processor 12 sets the aforementioned designated position as the threshold value in accordance with a determination operation performed by user u based on the line-superimposed image displayed on display 31a.

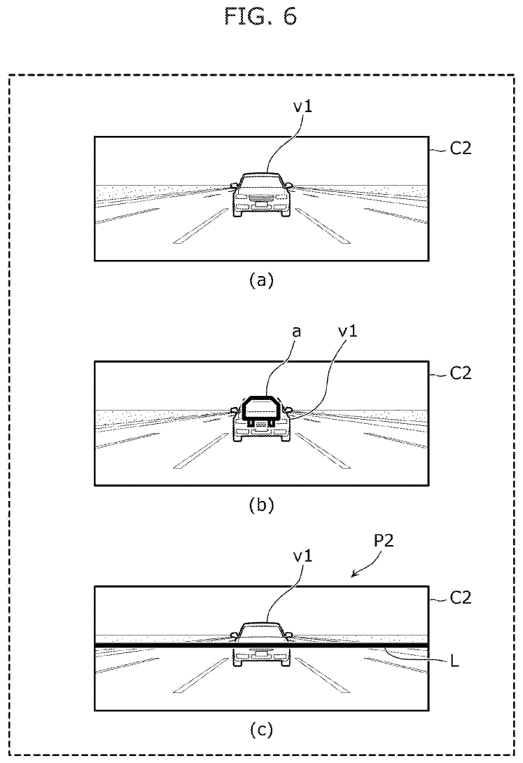

FIG. 6 is a diagram for describing the second threshold-value setting processing using the line-superimposed image according to the present embodiment.

For example, as shown in (a) in FIG. 6, rear vehicle v1 is shown in camera image C2 output from camera 20. In this case, object detector 21 detects rear vehicle v1 and outputs detection information indicating the result of the detection.

Here, if icon a is superimposed on camera image C2 showing rear vehicle v1 as shown in (b) in FIG. 6, the image of rear vehicle v1 and icon a may overlap each other. In this way, if the image of rear vehicle v1 and icon a overlap each other, it becomes difficult for user u to recognize icon a even if camera image C2 on which icon a has been superimposed is displayed on display 31a.

In view of this, image processor 11a according to the present embodiment does not superimpose icon a on camera image C2 upon acquiring the detection information indicating the detection of rear vehicle 1, and instead superimposes horizontal line L on camera image C2 as shown in (c) in FIG. 6 without superimposing icon a on camera image C2. Then, image processor 11a displays, on display 31a, camera image C2 on which horizontal line L has been superimposed, i.e., line-superimposed image P2. Specifically, image processor 11a superimposes horizontal line L so that the horizontal line passes through the designated position indicated by the icon information output from threshold-value processor 12. Then, user u confirms the position of horizontal line L by looking at line-superimposed image P2 displayed on display 31a, and if the position of the horizontal line is appropriate, performs a determination operation on actuator 32. As a result, threshold-value processor 12 sets the position of horizontal line L, i.e., the designated position, as the threshold value in accordance with a determination actuating signal output from actuator 32.

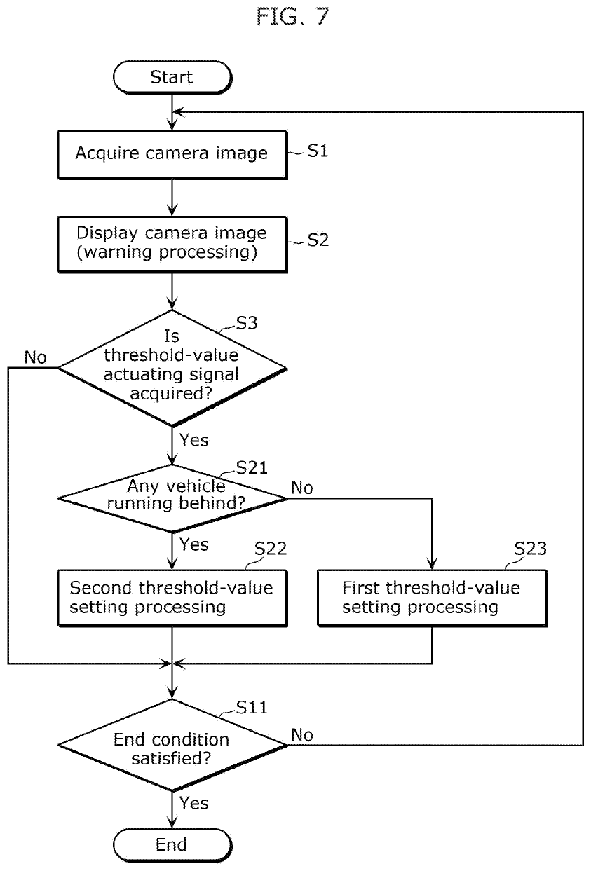

FIG. 7 is a flowchart showing one example of a processing operation of threshold-value setting device 10a according to the present embodiment.

Threshold-value setting device 10a performs the processing from steps S1 to S3 as in the processing operation according to Embodiment 1 shown in FIG. 4. Then, when a determination is made in step S3 that the threshold-value actuating signal is acquired (Yes in step S3), image processor 11a determines whether camera image C2 shows rear vehicle v1, on the basis of the detection information output from object detector 21 (step S21). When a determination is made that rear vehicle v1 is shown (Yes in step S21), image processor 11a performs the second threshold-value setting processing together with threshold-value processor 12 (step S22). On the other hand, when a determination is made that rear vehicle v1 is not shown (No in step S21), image processor 11a performs the first threshold-value setting processing together with threshold-value processor 12. In the first threshold-value setting processing, the processing from steps S4 to S10 shown in FIG. 4 is performed.

After execution of the processing in step S22 or S23, threshold-value setting device 10a determines whether end conditions are satisfied (step S11). When a determination is made that the end conditions are not satisfied (No in step S11), threshold-value setting device 10a repeats execution of the processing from step S1. On the other hand, when a determination is made that the end conditions are satisfied (Yes in step S11), threshold-value setting device 10a ends all processing.

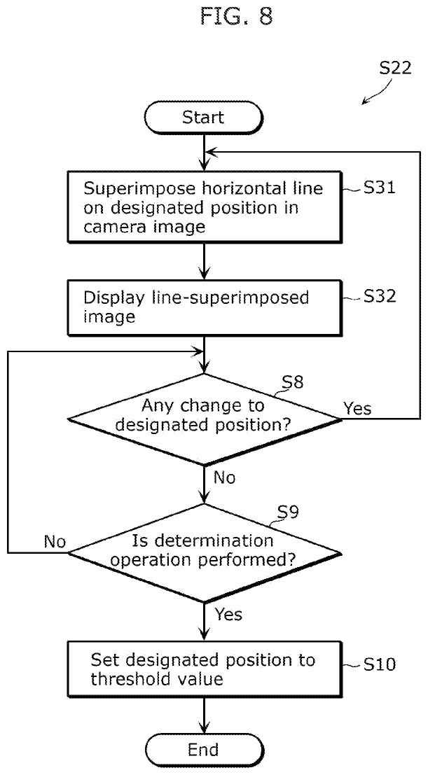

FIG. 8 is a flowchart showing one detailed example of the second threshold-value setting processing. FIG. 8 shows the details of the processing in step S22 in FIG. 7.

Image processor 11a superimposes horizontal line L on the designated position in camera image C2 (step S31). Then, image processor 11a displays, on display 31a, camera image C2 on which horizontal line L has been superimposed as line-superimposed image P2 (step S32). Then, threshold-value processor 12 performs the processing from steps S8 to S10 as in the flowchart shown in FIG. 4. In step S8 according to the present embodiment, when threshold-value processor 12 has determined that the designated position is changed (Yes in step S8), image processor 11a repeats execution of the processing from step S31.

As described thus far, in the present embodiment, the second threshold-value setting processing is performed when camera image C2 shows rear vehicle v1. In the second threshold-value setting processing, the threshold value is set without displaying icon-superimposed image P1, i.e., without superimposing and displaying icon a on camera image C2. Therefore, in the case where it may become difficult to recognize icon a, the threshold value is set without displaying icon a. This reduces the need for user u to perform troublesome operations in order to set the threshold value. In the second threshold-value setting processing according to the present embodiment, horizontal line L is superimposed and displayed on the designated position in camera image C2. Thus, even if horizontal line L is overlaid on the image of rear vehicle v1, it is possible to reduce the possibility that user u may have difficulty in recognizing horizontal line L. Then, user u is easily able to set the designated position as a threshold value by performing a determination operation while looking at horizontal line L. Accordingly, it is possible to easily set an appropriate threshold value for warning, irrespective of whether the camera image shows rear vehicle v1.

### Embodiment 3

As in Embodiment 2, a threshold-value setting device according to the present embodiment switches processing for setting a threshold value, depending on whether a camera image shows any other vehicle. Specifically, the processing is switched between first threshold-value setting processing and second threshold-value setting processing. Unlike in Embodiment 2, the second threshold-value setting processing according to the present embodiment uses frames of a camera image on which neither an icon nor horizontal line L is superimposed.

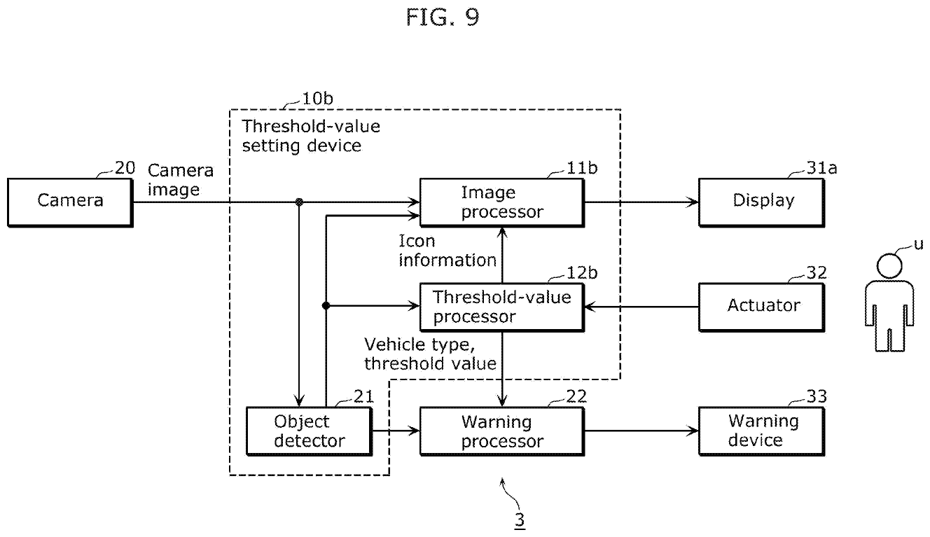

FIG. 9 is a block diagram showing a configuration of a warning system according to the present embodiment.

Warning system 3 according to the present embodiment includes threshold-value setting device 10b, camera 20, warning processor 22, display 31a, actuator 32, and warning device 33. Among constituent elements according to the present embodiment, those that are identical to constituent elements according to Embodiment 1 or 2 are given the same reference signs as in Embodiment 1 or 2, and detailed description thereof is omitted.

Like threshold-value setting device 10a according to Embodiment 2, threshold-value setting device 10b according to the present embodiment includes object detector 21. Threshold-value setting device 10b according to the present embodiment further includes image processor 11b and threshold-value processor 12b. Image processor 11b and threshold-value processor 12b also have the functions of image processor 11 and threshold-value processor 12 according to Embodiment 1, respectively. That is, when rear vehicle v1 is not detected by object detector 21, image processor 11b and threshold-value processor 12b according to the present embodiment perform the first threshold-value setting processing as in Embodiment 1. On the other hand, when rear vehicle v1 is detected by object detector 21, image processor 11b and threshold-value processor 12b according to the present embodiment perform the second threshold-value setting processing for setting the threshold value without displaying icon-superimposed image P1 on display 31a as in Embodiment 2.

Specifically, when detection information is acquired from object detector 21 and the detection information does not indicate rear vehicle v1, threshold-value processor 12b generates and outputs icon information as an operation of the first threshold-value setting processing. When detection information is acquired from object detector 21 and the detection information does not indicate rear vehicle v1, image processor 11b acquires icon information from threshold-value processor 12b and generates icon-superimposed image P1 as an operation of the first threshold-value setting processing.

On the other hand, when detection information is acquired from object detector 21 and the detection information indicates rear vehicle v1, image processor 11b displays camera image C2 showing rear vehicle v1 on display 31a as an operation of the second threshold-value setting processing. Specifically, image processor 11b displays camera image C2 on display 31a without superimposing any other object such as icon a and horizontal line L on camera image C2. In this way, in the second threshold-value setting processing, image processor 11b according to the present embodiment displays camera image C2 showing rear vehicle v1 on display 31a without superimposing any other objects on camera image C2.

Also, when detection information is acquired from object detector 21 and the detection information indicates rear vehicle v1, threshold-value processor 12b waits for the output of a selection actuating signal from actuator 32 as an operation of the second threshold-value setting processing. That is, user u operates actuator 32 with timing when rear vehicle v1 shown in camera image C2 arrives at a desired position while looking at camera image C2, the camera image being a moving image displayed on display 31a by image processor 11b described above. As a result, actuator 32 outputs the selection actuating signal to threshold-value processor 12b. Upon acquiring the selection actuating signal, threshold-value processor 12b sets the position of rear vehicle v1 indicated by the detection information at that time as the threshold value. In this way, threshold-value processor 12b according to the present embodiment sets, as the threshold value, the vertical position of rear vehicle v1 shown in a frame selected according to the selection operation by user u from among a plurality of frames included in camera image C2 that shows rear vehicle v1.

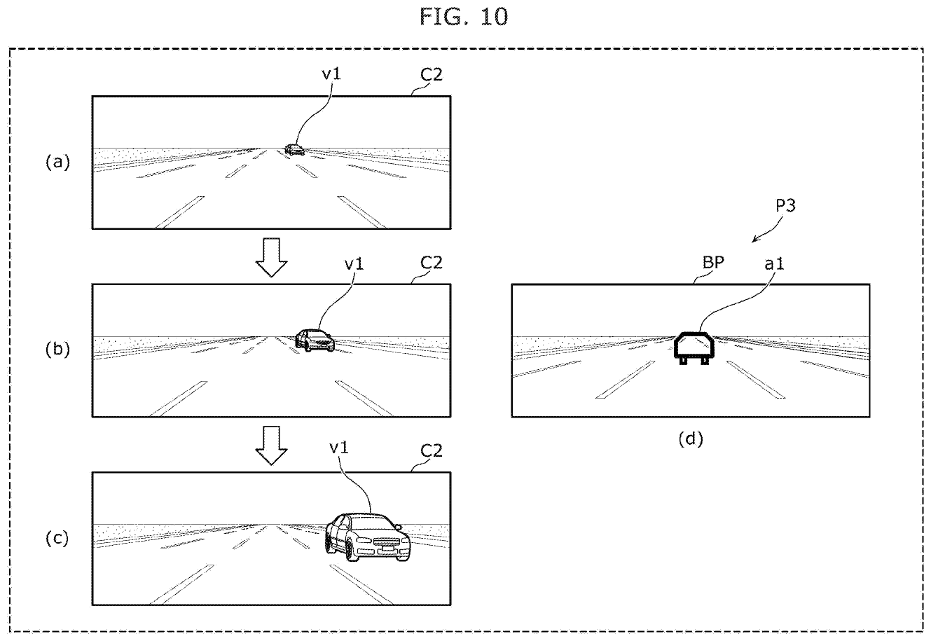

FIG. 10 is a diagram for describing the second threshold-value setting processing using frames according to the present embodiment. FIG. 10 shows three frames in time sequence, the three frames being included in camera image C2 showing rear vehicle v1.

For example, user u may stop vehicle V at a road shoulder and operate actuator 32 to set the threshold value. At this time, if the detection information indicates rear vehicle v1, image processor 11b displays camera image C2 on display 31a as an operation of the second threshold-value setting processing. That is, as shown in (a) to (c) in FIG. 10, image processor 11b sequentially displays each frame included in camera image C2 showing rear vehicle v1 on display 31a without superimposing any object on camera image C2. User u operates actuator 32 with timing when rear vehicle v1 shown in camera image C2 arrives at a desired position, while looking at camera image C2 displayed on display 31a as described above. For example, user u operates actuator 32 with timing when the frame shown in (b) in FIG. 10 is displayed on display 31a. In other words, user u performs a selection operation of selecting the frame shown in (b) in FIG. 10. As a result, actuator 32 outputs a selection actuating signal to threshold-value processor 12b. Upon acquiring the selection actuating signal, threshold-value processor 12b sets the position of rear vehicle v1 indicated by the detection information at that time as the threshold value. That is, threshold-value processor 12b sets the vertical position of rear vehicle v1 shown in the frame shown in (b) in FIG. 10 as the threshold value. In other words, threshold-value processor 12b selects the frame shown in (b) in FIG. 10 from camera image C2 in accordance with the selection operation by user u or the selection actuating signal and sets the position of rear vehicle v1 in that frame as the threshold value.

Here, threshold-value setting device 10b may allow user u to confirm the setting of the threshold value immediately before the threshold value is set. For example, as shown in (d) in FIG. 10, when the selection actuating signal is acquired, threshold-value processor 12b generates confirmation icon a1 that has a size appropriate to the position of rear vehicle v1 indicated by the detection information at that time and has a shape imitating the shape of rear vehicle v1. Then, threshold-value processor 12b outputs confirmation icon information that indicates confirmation icon a1 and the position of rear vehicle v1 to image processor 11b. Upon acquiring the confirmation icon information, image processor 11b superimposes confirmation icon a1 indicated by the confirmation icon information on the position of rear vehicle v1 in base image BP. Base image BP may be any image or frame as long as it does not show any other vehicle. Base image BP may be recorded camera image C1, or may be computer graphics (CG). Then, image processor 11b displays, on display 31a, base image BP on which confirmation icon at has been superimposed as confirmation image P3. Then, user u confirms the position of confirmation icon at by looking at confirmation image P3 displayed on display 31a and, if the position is appropriate, performs a determination operation on actuator 32. As a result, threshold-value processor 12b sets the position of rear vehicle v1 shown in the frame responsive to the aforementioned selection operation as the threshold value in accordance with the determination actuating signal output from actuator 32.

In this way, in the second threshold-value setting processing, when user u has performed a selection operation, image processor 11b superimposes confirmation icon at on position targeted for superimposition in base image BP that does not show rear vehicle v1, and displays, on display 31a, base image BP on which confirmation icon at has been superimposed as confirmation image P3. The position targeted for superimposition may, for example, be the same position as the vertical position of rear vehicle v1 shown in the frame responsive to the aforementioned selection operation shown in (b) in FIG. 10. Confirmation icon at has a size appropriate to the position targeted for superimposition and has a shape imitating the shape of rear vehicle v1 serving as the warning object. Threshold-value processor 12b sets the vertical position of rear vehicle v1 as the threshold value in accordance with the determination operation performed by user u based on displayed confirmation image P3.

Here, threshold-value setting device 10b according to the present embodiment performs the processing between the first threshold-value setting processing and the second threshold-value setting processing in accordance with the flowchart shown in FIG. 7.

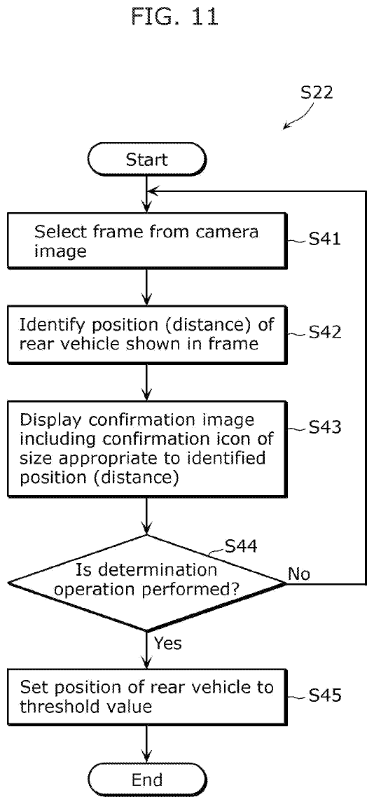

FIG. 11 is a flowchart showing one detailed example of the second threshold-value setting processing according to the present embodiment. Note that FIG. 11 shows the details of the processing in step S22 in FIG. 7.

First, threshold-value processor 12b selects a frame responsive to a selection operation by user u, i.e., appropriate to the selection actuating signal, from camera image C2 displayed on display 31a by image processor 11b (step S41). Then, threshold-value processor 12b identifies the vertical position of rear vehicle v1 shown in the frame in accordance with the detection information (step S42). At this time, threshold-value processor 12b may convert the vertical position into a distance from vehicle V to rear vehicle v1.

Then, threshold-value processor 12b generates confirmation icon at that has a size appropriate to the identified position (or distance) and has a shape imitating the shape of rear vehicle v1. Image processor 11b generates confirmation image P3 by superimposing confirmation icon at on the position targeted for superimposition in base image BP and displays the confirmation image on display 31a (step S43).

Next, threshold-value processor 12b determines whether a determination operation is performed by user u (step S44). That is, threshold-value processor 12b determines whether a determination actuating signal output from actuator 32 is received as a result of the determination operation performed by user u (step S44). Here, when a determination is made that the determination operation is performed (Yes in step S44), threshold-value processor 12b sets the position of rear vehicle v1 as the threshold value (step S45). At this time, threshold-value processor 12b outputs, to warning processor 22, the threshold value and a vehicle type that is indicated by the detection information together with the position of rear vehicle v1. On the other hand, when a determination is made that any determination operation is not performed (No in step S44), threshold-value processor 12b repeats execution of the processing from step S41.

In this way, in the second threshold-value setting processing according to the present embodiment, when a frame indicating a situation in which rear vehicle v1 is approaching within a desired distance from vehicle V, user u performs a selection operation while looking at camera image C2. Then, the vertical position of rear vehicle v1 shown in the frame responsive to this selection operation by user u is set as the threshold value. Thus, user u is easily able to set the threshold value while grasping the relationship between the threshold value and the distance from vehicle V to the warning object. Accordingly, it is possible to easily set an appropriate threshold value for warning, irrespective of whether the camera image shows rear vehicle v1.

In the second threshold-value setting processing according to the present embodiment, when a selection operation is performed by user u, confirmation image P3 is displayed on display 31a before the threshold value is set. Confirmation image P3 is such that confirmation icon at is superimposed on base image BP that does not show rear vehicle v1. Thus, user u is easily able to recognize confirmation icon at. Besides, confirmation icon at has a shape appropriate to the vertical position of rear vehicle v1 (i.e., the position targeted for superimposition) shown in the frame selected by the selection operation and has a shape imitating the shape of rear vehicle v1. The vertical position of rear vehicle v1, i.e., the position targeted for superimposition, is assumed to be a provisional threshold value. Thus, taking a look at confirmation icon at allows user u to easily grasp the relationship between the provisional threshold value and the distance from vehicle V to the warning object. Then, user u is easily able to set the vertical position of rear vehicle v1 as the threshold value by performing a determination operation while looking at confirmation icon at. Accordingly, it is possible to easily set an appropriate threshold value for warning, irrespective of whether the camera image shows rear vehicle v1.

### Embodiment 4

As in Embodiments 2 and 3, a threshold-value setting device according to the present embodiment switches processing for setting a threshold value depending on whether the camera image shows any other vehicle. Specifically, the processing is switched between the first threshold-value setting processing and the second threshold-value setting processing. The second threshold-value setting processing according to the present embodiment uses recording, unlike in Embodiments 2 and 3.

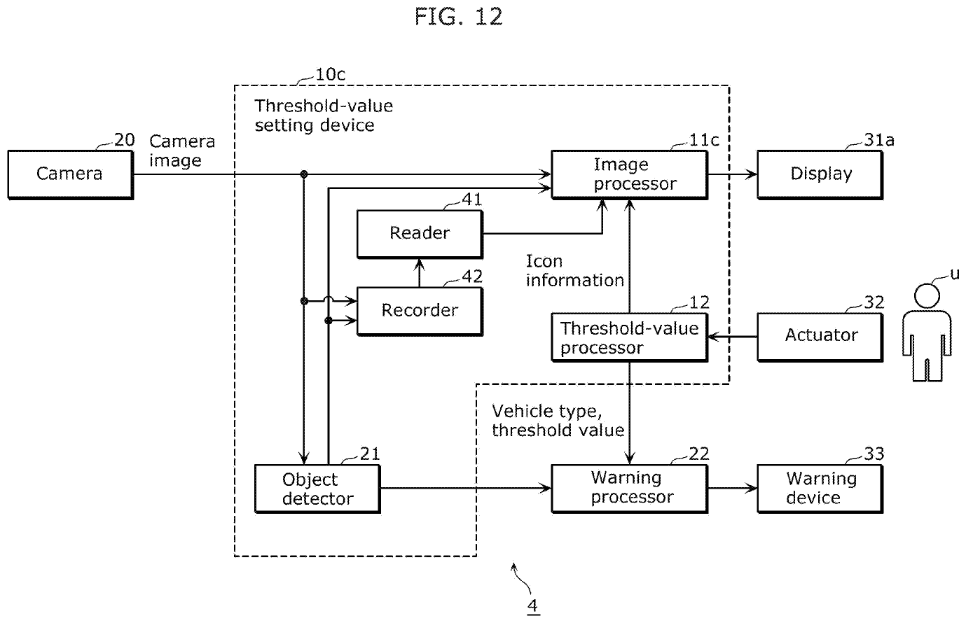

FIG. 12 is a block diagram showing a configuration of a warning system according to the present embodiment.

Warning system 4 according to the present embodiment includes threshold-value setting device 10c, camera 20, warning processor 22, display 31a, actuator 32, and warning device 33. Among constituent elements according to the present embodiment, those that are identical to constituent elements according to Embodiments 1 to 3 are given the same reference signs as in Embodiments 1 to 3, and detailed description thereof is omitted.

Like threshold-value setting device 10a according to Embodiment 2, threshold-value setting device 10c according to the present embodiment includes object detector 21. Threshold-value setting device 10c according to the present embodiment further includes image processor 11c, threshold-value processor 12, reader 41, and recorder 42. Image processor 11c also has the function of image processor 11 according to Embodiment 1. That is, when rear vehicle v1 is not detected by object detector 21, image processor 11c and threshold-value processor 12 according to the present embodiment perform the first threshold-value setting processing as in Embodiments 1 to 3. On the other hand, when rear vehicle v1 is detected by object detector 21, threshold-value setting device 10c according to the present embodiment performs the second threshold-value setting processing for setting the threshold value without displaying icon-superimposed image P1 on display 31a as in Embodiments 2 and 3. Note that icon-superimposed image P1 according to the present embodiment is an image obtained by superimposing icon a generated by threshold-value processor 12 on the camera image obtained by current image capturing with camera 20.

Specifically, when detection information is acquired from object detector 21 and the detection information does not indicate rear vehicle V1, recorder 42 records camera image C1. That is, when rear vehicle v1 is not detected by object detector 21, recorder 42 records camera image C1 as a recorded image.

In response to a request from image processor 11c, reader 41 reads out camera image C1 recorded by recorder 42 as a recorded image from recorder 42 and outputs the recorded image to image processor 11c.

When the detection information is acquired from object detector 21 and the detection information does not indicate rear vehicle v1, image processor 11c acquires icon information from threshold-value processor 12 and generates icon-superimposed image P1 as an operation of the first threshold-value setting processing.

On the other hand, when detection information is acquired from object detector 21 and the detection information indicates rear vehicle v1, image processor 11c requests reader 41 to read out the recorded image as an operation of the second threshold-value setting processing. Then, image processor 11c acquires the recorded image from recorder 42 via reader 41 and superimposes an icon on the recorded image, instead of on camera image C2 showing rear vehicle v1.

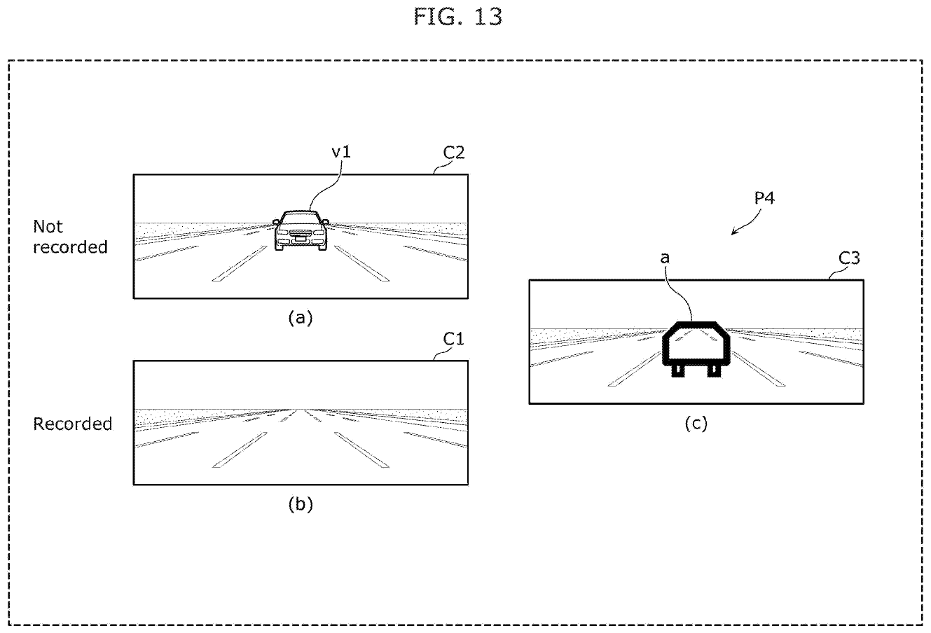

FIG. 13 is a diagram for describing the second threshold-value setting processing using the recorded image according to the present embodiment.

For example, when camera image C2 shows rear vehicle v1 as shown in (a) in FIG. 13, recorder 42 does not record camera image C2. On the other hand, when camera image C1 does not show rear vehicle v1 as shown in (b) in FIG. 13, recorder 42 records camera image C1 as recorded image C3. Note that recorder 42 determines whether camera image C1 or C2 shows rear vehicle v1, on the basis of the detection information output from object detector 21.

Then, in the second threshold-value setting processing, image processor 11c acquires recorded image C3 from recorder 42 via reader 41 and superimposes icon a on recorded image C3, instead of on camera image C2, as shown in (c) in FIG. 13. This superimposition of icon a on recorded image C3 produces icon-superimposed recorded image P4. Note that the position on which icon a is superimposed is the designated position indicated by the threshold-value actuating signal. Then, image processor 11c displays icon-superimposed recorded image P4 on display 31a.

User u confirms the position of icon a by looking at icon-superimposed recorded image P4 displayed on display 31a and, if the position is appropriate, performs a determination operation on actuator 32. As a result, threshold-value processor 12 sets the position of icon a, i.e., the designated position, as the threshold value in accordance with the determination actuating signal output from actuator 32.

In this way, in the second threshold-value setting processing according to the present embodiment, image processor 11c superimposes icon a generated by threshold-value processor 12 on the designated position in recorded image C3, which is recorded in the past by recorder 42, and displays, on display 31a, recorded image C3 on which icon a has been superimposed as icon-superimposed recorded image P4. Then, threshold-value processor 12 sets the aforementioned designated position as the threshold value in accordance with the determination operation performed by user u based on displayed icon-superimposed recorded image P4.

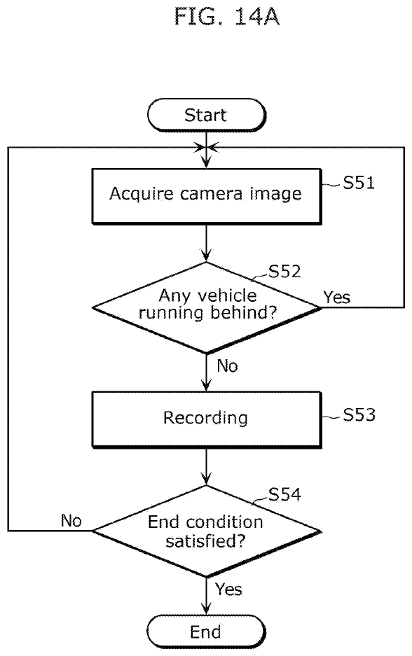

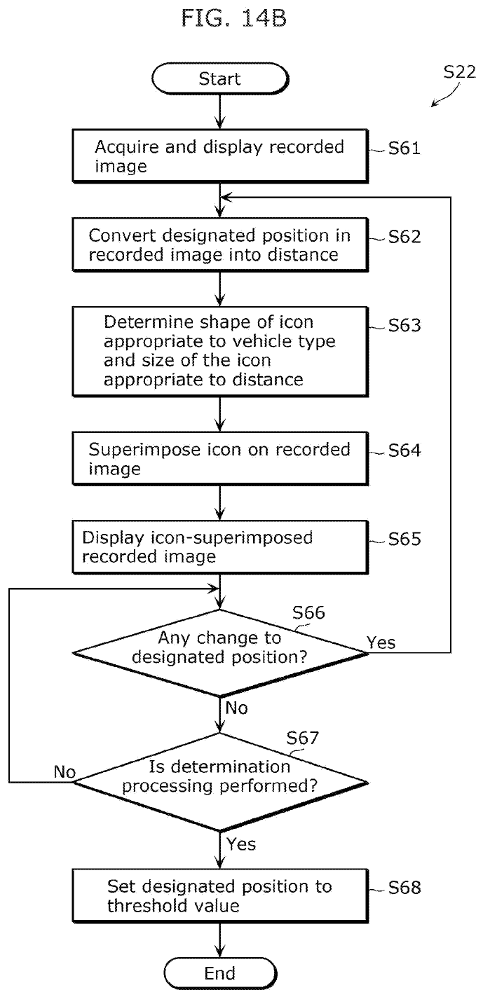

FIG. 14A is a flowchart showing one example of a processing operation of recorder 42.

First, recorder 42 acquires a camera image from camera 20 (step S51). Then, recorder 42 determines on the basis of the detection information whether the camera image shows rear vehicle v1 (step S52). Here, when a determination is made that the camera image shows rear vehicle v1 (Yes in step S52), recorder 42 repeats execution of the processing from step S51. On the other hand, when a determination is made that the camera image does not show rear vehicle v1 (No in step S52), recorder 42 records the camera image as recorded image C3 (step S53). Then, recorder 42 determines whether end conditions are satisfied (step S54) and, when a determination is made that the end conditions are not satisfied (No in step S54), repeats execution of the processing from step S51. On the other hand, when a determination is made that the end conditions are satisfied (Yes in step S54), recorder 42 ends all processing. Like the end conditions described in step S11 in FIG. 4, the end conditions may include, for example, power-off of warning system 1 or power-off of the ignition switch of vehicle V, and may be any conditions.

Here, threshold-value setting device 10c according to the present embodiment switches the processing between the first threshold-value setting processing and the second threshold-value setting processing in accordance with the flowchart shown in FIG. 7.

FIG. 14B is a flowchart showing one detailed example of the second threshold-value setting processing according to the present embodiment. FIG. 14B shows the details of the processing in step S22 in FIG. 7.

First, image processor 11c acquires recorded image C3 and displays the recorded image on display 31a (step S61). Next, threshold-value processor 12 converts the designated position indicated by the threshold-value actuating signal into distance (step S62). The designated position refers to a vertical position in recorded image C3, and the distance refers to a distance from vehicle V to the position corresponding to the designated position in real space. This conversion uses patterns of camera 20. Threshold-value processor 12 further determines the shape of an icon imitating the shape of the vehicle type indicated by the threshold-value actuating signal and the size of the icon appropriate to the distance (step S63). In this way, the icon is generated. Then, threshold-value processor 12 generates icon information that indicates the designated position and the icon of the determined shape and size to image processor 11c. Although in steps S62 and 63, the designated position is converted into distance and the size of the icon appropriate to the distance is determined, the size of the icon may be determined directly from the designated position without conversion of the designated position into distance.

Upon acquiring the icon information from threshold-value processor 12, image processor 11c superimposes the icon indicated by the icon information on the designated position in recorded image C3 indicated by the icon information (step S64). Then, image processor 11c displays, on display 31a, recorded image C3 on which the icon has been superimposed, i.e., icon-superimposed recorded image P4 (step S65).

Here, threshold-value processor 12 determines whether the threshold-value actuating signal is changed, i.e., whether the designated position indicated by the threshold-value actuating signal is changed (step S66). When a determination is made that the designated position is changed (Yes in step S66), threshold-value processor 12 repeats execution of the processing from step S62. On the other hand, when a determination is made that the designated position is not changed (No in step S66), threshold-value processor 12 further determines whether a determination actuating signal is acquired from actuator 32 (step S67). When a determination is made that any determination actuating signal is not acquired (No in step S67), threshold-value processor 12 repeats execution of the processing from step S66. On the other hand, when a determination is made that the determination actuating signal is acquired (Yes in step S67), threshold-value processor 12 sets the designated position indicated by the last threshold-value actuating signal as the threshold value (step S68).

As described thus far, in the second threshold-value setting processing according to the present embodiment, icon a is superimposed and displayed on recorded image C3, which is camera image C2 recorded in the past and in which rear vehicle v1 is not shown. Thus, user u is easily able to recognize icon a. Then, user u is able to easily set the designated position as the threshold value by performing a determination operation while looking at icon a. Accordingly, it is possible to easily set an appropriate threshold value for warning, irrespective of whether the camera image shows rear vehicle v1.

### Embodiment 5

As in Embodiments 2 to 4, a threshold-value setting device according to the present embodiment switches processing for setting a threshold value depending on whether a camera image shows any other vehicle. Specifically, the processing is switched between the first threshold-value setting processing and the second threshold-value setting processing. The second threshold-value setting processing according to the present embodiment further involves selection of a recorded frame, unlike in Embodiments 2 to 4.

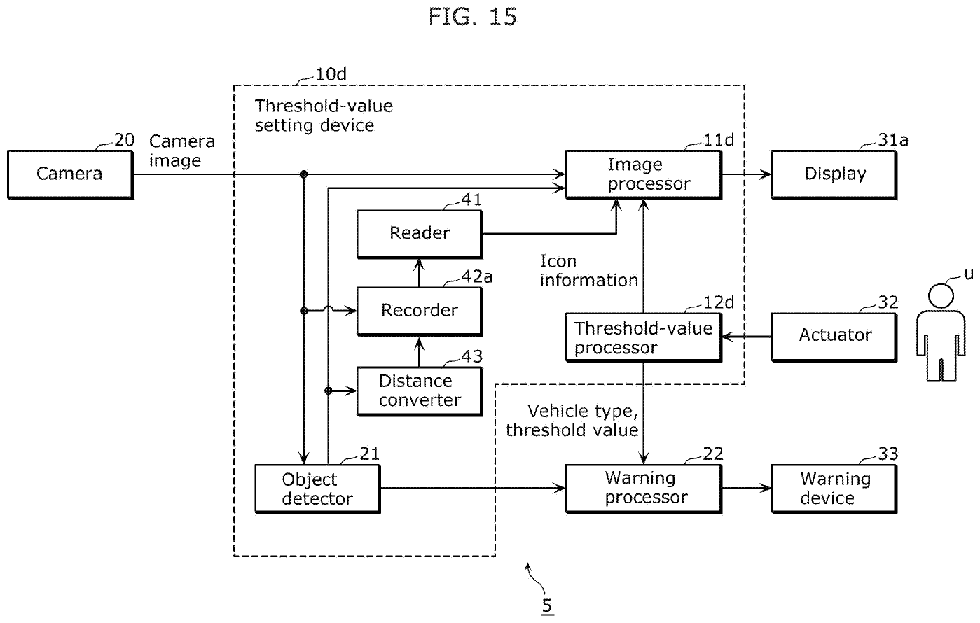

FIG. 15 is a block diagram showing a configuration of a warning system according to the present embodiment.

Warning system 5 according to the present embodiment includes threshold-value setting device 10d, camera 20, warning processor 22, display 31a, actuator 32, and warning device 33. Among constituent elements according to the present embodiment, those that are identical to constituent elements according to Embodiments 1 to 4 are given the same reference signs as in Embodiments 1 to 4, and detailed description thereof is omitted.

Like threshold-value setting device 10a according to Embodiment 2, threshold-value setting device 10d according to the present embodiment includes object detector 21. Threshold-value setting device 10d according to the present embodiment further includes image processor 11d, threshold-value processor 12d, reader 41, recorder 42a, and distance converter 43. Image processor 11d and threshold-value processor 12d also have the functions of image processor 11 and threshold-value processor 12 according to Embodiment 1, respectively. That is, when rear vehicle v1 is not detected by object detector 21, image processor 11d and threshold-value processor 12d according to the present embodiment perform the first threshold-value setting processing as in Embodiments 1 to 4. On the other hand, when rear vehicle v1 is detected by object detector 21, threshold-value setting device 10d according to the present embodiment performs the second threshold-value setting processing for setting the threshold value without displaying icon-superimposed image P1 on display 31a as in Embodiments 2 to 4.

Specifically, when detection information is acquired from object detector 21 and the detection information indicates the position of rear vehicle v1, distance converter 43 converts that position into a vehicle-to-vehicle distance from vehicle V to rear vehicle v1. The position of rear vehicle v1 indicated by the detection information is the vertical position of rear vehicle v1 shown in a frame of camera image C2. Thus, it can also be said that distance converter 43 performs distance conversion processing for converting the vertical position of rear vehicle v1 shown in camera image C2 into vehicle-to-vehicle distance. As a result, the vehicle-to-vehicle distance is derived for each frame included in camera image C2. Then, distance converter 43 outputs the vehicle-to-vehicle distance to recorder 42a. Note that parameters of camera 20 are used in the conversion of the position of rear vehicle v1 into the vehicle-to-vehicle distance.

Upon acquiring the vehicle-to-vehicle distance from distance converter 43, recorder 42a determines whether the vehicle-to-vehicle distance is equal to any of a plurality of set distances defined in advance. Examples of the set distances include 10 m, 20 m, and 30 m, but the set distances are not limited thereto and may be 1 m, 2 m, and 3 m. When a determination is made that the vehicle-to-vehicle distance is equal to any of the set distances, recorder 42a records a frame that corresponds to the vehicle-to-vehicle distance included in camera image C2. The frame corresponding to the vehicle-to-vehicle distance is a frame that shows rear vehicle v1 running behind and away from vehicle V by the vehicle-to-vehicle distance. Alternatively, the frame corresponding to the vehicle-to-vehicle distance may be a frame that is used by object detector 21 in order to generate detection information to be used in the conversion into the vehicle-to-vehicle distance. When recording these frames, recorder 42a associates each frame with the vehicle-to-vehicle distance (i.e., set distance) derived for the frame.

In this way, in the second threshold-value setting processing, recorder 42a according to the present embodiment records a plurality of frames included in camera image C2. Specifically, for each of the set distances defined in advance, recorder 42a records a frame corresponding to the vehicle-to-vehicle distance equal to the set distance.

In response to a request from image processor 11d, reader 41 reads out a plurality of frames, each recorded in association with the vehicle-to-vehicle distance by recorder 42a, from recorder 42a and outputs these frames to image processor 11d.

When detection information is acquired from object detector 21 and the detection information does not indicate rear vehicle v1, image processor 11d acquires icon information from threshold-value processor 12d and generates icon-superimposed image P1 as an operation of the first threshold-value setting processing.

On the other hand, when detection information is acquired from object detector 21 and the detection information indicates rear vehicle v1, image processor 11d requests reader 41 to read out a plurality of frames as an operation of the second threshold-value setting processing. Then, image processor 11d acquires a plurality of frames from recorder 42a via reader 41 and displays these recorded frames on display 31a in association with the aforementioned set distances. In the second threshold-value setting processing, threshold-value processor 12d sets the vertical position of rear vehicle v1 shown in a selected frame as the threshold value, the selected frame being selected according to a selection operation by user u in which one frame is selected from among a plurality of displayed frames. That is, when a selection actuating signal is acquired that is output from actuator 32 as a result of the aforementioned selection operation, threshold-value processor 12d acquires detection information corresponding to the frame identified by the selection actuating signal from object detector 21. Then, threshold-value processor 12d sets the vertical position of rear vehicle v1 indicated by the detection information as the threshold value.

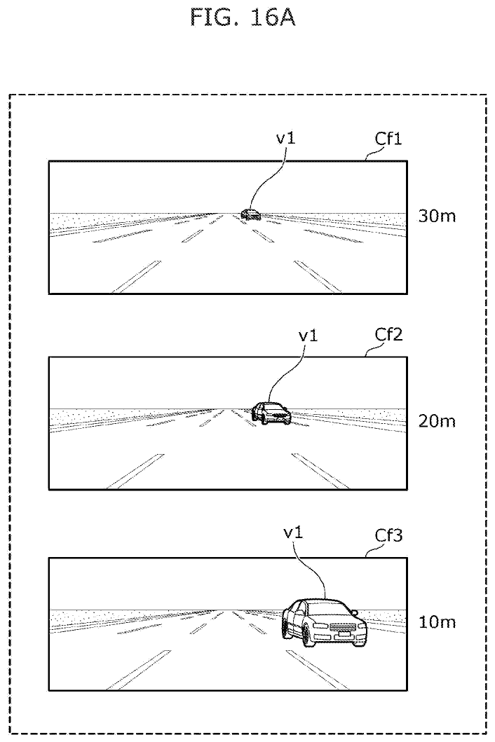

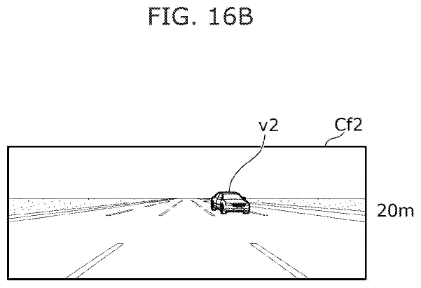

FIGS. 16A and 16B are diagrams each showing one example of the image displayed in the second threshold-value setting processing according to the present embodiment.

For example, user u may stop vehicle V at a road shoulder and operate actuator 32 to set the threshold value. At this time, in the second threshold-value setting processing, image processor 11d acquires frames Cf1, Cf2, and Cf3 and displays frames Cf1, Cf2, and Cf3 in association with each of the set distances as shown in FIG. 16A. For example, frame Cf1 is displayed in association with a set distance of “30 m”. Frame Cf1 shows rear vehicle v1 that is running behind and away from vehicle V by the set distance of “30 m”. Frame Cf2 is displayed in association with a set distance of “20 m”. Frame Cf2 shows rear vehicle v1 that is running behind and away from vehicle V by the set distance of “20 m”. Frame Cf3 is displayed in association with a set distance of “10 m”. Frame Cf3 shows rear vehicle v1 that is running behind and away from vehicle V by the set distance of “10 m”.

While looking at the image displayed in this way on display 31a, user u operates actuator 32 to perform a selection operation of selecting a frame associated with a desired set distance. For example, frame Cf2 may be selected. As a result, actuator 32 outputs a selection actuating signal for identifying frame Cf2. Upon acquiring the selection actuating signal, threshold-value processor 12d outputs the selection actuating signal to image processor 11d. As shown in FIG. 16B, image processor 11d displays frame Cf2 identified by the selection actuating signal in association with the set distance of “20 m”. Threshold-value processor 12d also acquires detection information corresponding to frame Cf2 identified by the selection actuating signal from object detector 21. Then, threshold-value processor 12d sets the vertical position of rear vehicle v1 indicated by the detection information as the threshold value.

Here, threshold-value setting device 10d according to the present embodiment switches the processing between the first threshold-value setting processing and the second threshold-value setting processing in accordance with the flowchart shown in FIG. 7.

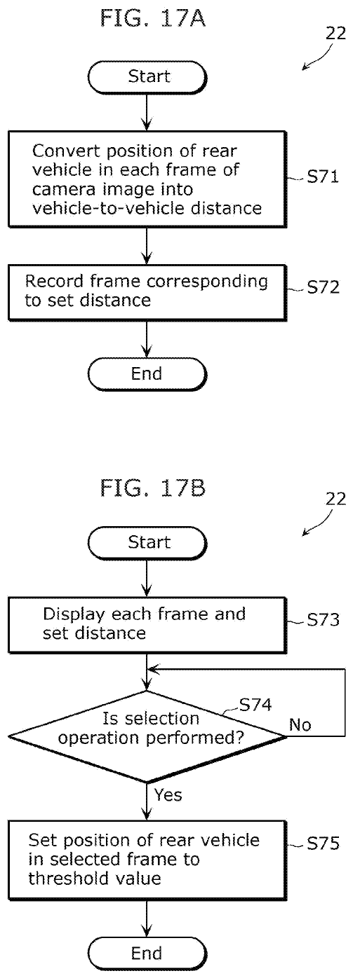

FIGS. 17A and 17B are flowcharts showing one detailed example of the second threshold-value setting processing according to the present embodiment. FIGS. 17A and 17B show details of the processing in step S22 in FIG. 7.

First, for each of a plurality of frames included in camera image C2, distance converter 43 converts the vertical position of rear vehicle v1 shown in the frame into vehicle-to-vehicle distance (step S71). Next, for each of a plurality of set distances defined in advance, recorder 42a records a frame corresponding to a vehicle-to-vehicle distance equal to the set distance among the aforementioned frames (step S72).

Then, for each of the frames recorded in step S72, image processor 11d displays the frame and the set distance corresponding to the frame on display 31a in association with each other (step S73).

Next, threshold-value processor 12d determines whether a selection operation of selecting any of the displayed frames is performed by user u (step S74). That is, threshold-value processor 12d determines whether a selection actuating signal is acquired from actuator 32. When a determination is made that the selection operation is not performed (No in step S74), threshold-value processor 12d repeats execution of the processing from step S74. That is, threshold-value processor 12d waits until a selection operation is performed. On the other hand, when a determination is made that the selection operation is performed (Yes in step S74), threshold-value processor 12d sets the vertical position of rear vehicle v1 shown in the frame selected by the selection operation as the threshold value (step S75).

Note that the processing in steps S71 and S72 shown in FIG. 17A may be performed separately from the second threshold-value setting processing. That is, the processing in steps S71 and S72 may be performed with any timing as long as it is performed before the processing from steps S73 to S75. Then, image processor 11d and threshold-value processor 12d may perform the processing from steps S73 to S75 when a determination is made in step S3 shown in FIG. 7 that the threshold-value actuating signal is acquired. In other words, for each of a plurality of set distances defined in advance, recorder 42a records a frame corresponding to the vehicle-to-vehicle distance equal to the set distance. Thereafter, in the second threshold-value setting processing, image processor 11d displays a plurality of recorded frames on display 31a in association with the plurality of set distances, respectively, and threshold-value processor 12d sets the vertical position of another vehicle shown in the selected frame as the threshold value, the selected frame being selected according to the selection operation of selecting one of a plurality of displayed frames by the user.

In this way, in the second threshold-value setting processing according to the present embodiment, a plurality of frames included in camera image C2 showing rear vehicle v1 are displayed in association with a plurality of set distances, respectively. The position of rear vehicle v1 in each frame displayed in this manner is regarded as a candidate for the threshold value. Then, the vertical position of rear vehicle v1 shown in the frame selected from among those frames in response to the selection operation by user u is set as the threshold value. Thus, user u is easily able to set a desired threshold value by selecting a frame while grasping, for each of a plurality of frames, the relationship between the candidate for the threshold value for the frame and the vehicle-to-vehicle distance corresponding to the frame with ease and in no hurry. As a result, it is possible to easily set an appropriate threshold value for warning, irrespective of whether the camera image shows rear vehicle v1.

While the threshold-value setting device according one or a plurality of aspects has been described thus far in accordance with several embodiments, the present disclosure is not intended to be limited to these embodiments. The present disclosure may also include other variations obtained by making various modifications conceivable by those skilled in the art to the embodiments, without departing from the scope of the present disclosure. The present disclosure may also include any combination of a plurality of embodiments described above.

For example, although the threshold-value setting devices according to Embodiments 2 to 5 switch the processing between the first threshold-value setting processing and the second threshold-value setting processing, only the second threshold-value setting processing may be performed without switching. The icon generated by the threshold-value processor has a shape imitating the shape of the warning object, but in the case where the warning object is a four-wheel vehicle, the icon may simply be a rectangular icon, or in the case where the warning object is a two-wheel vehicle, the icon may be a longitudinally rectangular icon smaller than the icon of a four-wheel vehicle. The icon may also be a mark having only the contour, or may be a mark filled in a predetermined color. As another alternative, the color of the icon corresponding to the warning object may be determined depending on the type of the warning object.

In each of the above-described embodiments, each constituent element may be configured by dedicated hardware, or may be implemented by executing a software program suitable for the constituent element. Each constituent element may also be implemented by a program executor such as a central processing unit (CPU) or a processor reading out and executing a software program recorded on a recording medium such as a hard disk or semiconductor memory. Here, the program that is software for implementing a device or system such as the threshold-value setting device according to each of the above-described embodiments causes a computer to execute each step included in the flowcharts shown in FIGS. 4, 7, 8, 11, 14A, 14B, and 17.

Note that the following cases are also included in the present disclosure.

(1) The above-described devices each may specifically be a computer system configured by, for example, a microprocessor, read only memory (ROM), random access memory (RAM), a hard disk unit, a display unit, a keyboard, and a mouse. The RAM or the hard disk unit stores computer programs. At least one of the above-described devices achieves its function as a result of the microprocessor operating in accordance with the computer programs. The computer programs as used herein are configured by a combination of a plurality of instruction codes that indicate commands given to the computer in order to achieve predetermined functions.

(2) Some or all of the constituent elements of the above-described devices may be configured as single system large-scale integration (LSI). The system LSI is ultra-multifunctional LSI manufactured by integrating a plurality of components on a single chip, and specifically a computer system that may include, for example, a microprocessor, ROM, and RAM. The RAM stores computer programs. The system LSI achieves its function as a result of the microprocessor operating in accordance with the computer programs.

(3) Some or all of the constituent elements of the above-described devices may be configured as an IC card or a stand-alone module that is detachable from the devices. The IC card or the module may be a computer system that may include, for example, a microprocessor, ROM, and RAM. The IC card or the module may include the aforementioned ultra-multifunctional LSI. The IC card or the module achieves its function as a result of the microprocessor operating in accordance with the computer programs. The IC card or the module may have protection against tampering.

(4) The present disclosure may be implemented as the above-described methods. The present disclosure may also be implemented as a computer program that realizes these methods via a computer, or may be implemented as digital signals generated by the computer program.

The present disclosure may also be implemented by recording the computer programs or the digital signals on a computer-readable recording medium such as a flexible disk, a hard disk, a compact disc (CD)-ROM, a DVD, a DVD-ROM, a DVD-RAM, a Blu-ray (BD: registered trademark) disc, or a semiconductor memory. The present disclosure may also be implemented as digital signals recorded on such a recording medium.

The present disclosure may be implemented by transmitting computer programs or digital signals via, for example, telecommunication lines, wireless or wired communication lines, networks typified by the Internet, or data communications.

The present disclosure may also be implemented as another independent computer system by transferring programs or digital signals recorded on a recording medium or by transferring programs or digital signals via, for example, a network.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims are incorporated herein by reference in their entirety: Japanese Patent Application No. 2023-053990 filed on Mar. 29, 2023.

### INDUSTRIAL APPLICABILITY

The threshold-value setting device according to present disclosure is applicable to a system or the like that is capable of easily setting an appropriate threshold value for warning about, for example, the approach of a rear vehicle and that is capable of issuing a warning thereabout.

1. A threshold-value setting device for setting a threshold value that corresponds to a predetermined distance from a vehicle in order to give a user a warning about a warning object approaching within a distance less than the predetermined distance, the threshold-value setting device comprising:
a circuit; and
memory connected to the circuit,
wherein, using the memory, the circuit:
acquires a designated position in accordance with an operation by a user, the designated position being a vertical position in a camera image obtained by image capturing of surroundings of the vehicle with a camera provided to the vehicle;
generates an icon having a size appropriate to the designated position and a shape imitating a shape of the warning object;
superimposes the icon generated, on the designated position in the camera image;
displays, on a display, the camera image on which the icon has been superimposed as an icon-superimposed image; and
sets the designated position as the threshold value in accordance with a determination operation performed by the user based on the icon-superimposed image displayed.

2. The threshold-value setting device according to claim 1,
wherein the circuit further:
detects an other vehicle running in a vicinity of the vehicle through image recognition processing performed on the camera image;
when the other vehicle is not detected, performs first threshold-value setting processing in which the threshold value is set by displaying the icon-superimposed image; and
when the other vehicle is detected, performs second threshold-value setting processing in which the threshold value is set without displaying the icon-superimposed image.

3. The threshold-value setting device according to claim 2,
wherein, in the second threshold-value setting processing, the circuit:
superimposes, on the camera image, a horizontal line passing through the designated position in the camera image;
displays, on the display, the camera image on which the horizontal line has been superimposed as a line-superimposed image; and
sets the designated position as the threshold value in accordance with a determination operation performed by the user based on the line-superimposed image displayed.

4. The threshold-value setting device according to claim 2,
wherein, in the second threshold-value setting processing, the circuit:
displays the camera image on the display without superimposing any object on the camera image that shows the other vehicle; and
sets, as the threshold value, a vertical position of the other vehicle shown in a frame selected according to a selection operation by the user from among a plurality of frames included in the camera image that shows the other vehicle.

5. The threshold-value setting device according to claim 4,
wherein when the selection operation is performed by the user, the circuit superimposes a confirmation icon on a position targeted for superimposition in a base image that does not show the other vehicle, and displays, on the display, the base image on which the confirmation icon has been superimposed as a confirmation image,
the position targeted for superimposition is a same position as the vertical position of the other vehicle shown in the frame selected according to the selection operation,
the confirmation icon has a size appropriate to the position targeted for superimposition and has a shape imitating a shape of the other vehicle, and
the circuit sets the vertical position of the other vehicle as the threshold value in accordance with a determination operation performed by the user based on the confirmation image displayed.

6. The threshold-value setting device according to claim 2,
wherein when the other vehicle is not detected, the circuit further records the camera image as a recorded image,
the icon-superimposed image is an image obtained by superimposing the icon generated on the camera image obtained by current image capturing with the camera, and
in the second threshold-value setting processing, the circuit:
superimposes the icon generated, on the designated position in the recorded image recorded in the past;
displays, on the display, the recorded image on which the icon has been superimposed as an icon-superimposed recorded image; and
sets the designated position as the threshold value in accordance with a determination operation performed by the user based on the icon-superimposed recorded image displayed.

7. The threshold-value setting device according to claim 2,
wherein the circuit further:
performs distance conversion processing for converting a vertical position of the other vehicle shown in the camera image into a vehicle-to-vehicle distance from the vehicle to the other vehicle; and
records a plurality of frames included in the camera image,
when recording the plurality of frames, the circuit records, for each of a plurality of set distances defined in advance, a frame that corresponds to the vehicle-to-vehicle distance equal to the set distance, and
in the second threshold-value setting processing, the circuit:
displays the plurality of frames recorded on the display in association with the plurality of set distances, respectively; and
sets, as the threshold value, the vertical position of the other vehicle shown in a frame selected by a selection operation by a user from among the plurality of frames displayed.

8. A threshold-value setting method for setting a threshold value that corresponds to a predetermined distance from a vehicle in order to give the vehicle a warning about a warning object approaching within a distance less than the predetermined distance, the threshold-value setting method comprising:
acquiring a designated position in accordance with an operation by a user, the designated position being a vertical position in a camera image obtained by image capturing of surroundings of the vehicle with a camera provided to the vehicle;
generating an icon having a size appropriate to the designated position and having a shape imitating a shape of the warning object;
superimposing the icon generated, on the designated position in the camera image;
displaying, on a display, the camera image on which the icon has been superimposed as an icon-superimposed image; and
setting the designated position as the threshold value in accordance with a determination operation performed by the user based on the icon-superimposed image displayed.
